(19) United States
(12) Patent Application Publication
(10) Pub. No.: US 2014/0252958 A1
(43) Pub. Date: Sep. 11, 2014

(54) WIRELESS CONTROLLED LIGHT SOURCES

(71) Applicants: Bryan Subotnick, Los Angeles, CA (US); Spot On Networks, LLC, New Haven, CT (US); Wavien, Inc., Valencia, CA (US)

(72) Inventors: Bryan SUBOTNICK, Los Angeles, CA (US); Richard SHERWIN, New York, NY (US); Kenneth LI, Castaic, CA (US)

(73) Assignees: Spot On Networks, LLC, New Haven, CT (US); Wavien, Inc., Valencia, CA (US)

(21) Appl. No.: 14/199,465

(22) Filed: Mar. 6, 2014

Related U.S. Application Data
(60) Provisional application No. 61/773,640, filed on Mar. 6, 2013.
(60) Provisional application No. 61/810,401, filed on Apr. 10, 2013.

(51) Int. Cl. H05B 37/02; H05B 33/08

(52) U.S. Cl. CPC H05B 37/02; H05B 33/0845
USPC 315/149; 315/291; 315/307

(57) ABSTRACT

A network comprises a plurality of modules, wherein each module comprises a communications circuit with an antenna for sending information signals to and receiving control signals from a remote base over a wifi connection. Each module includes either a lighting element or a security camera for providing images. Each module may further include sensors to provide information to the base concerning operating conditions. Preferably, each module is programmed to receive signals from other modules and to relay such signals to the remote base, and similarly route control signals from the remote base intended for a different module to the intended module. In one embodiment, the network is a lighting network in which each module includes a light source controlled by the remote base or by a control terminal connected to the remote base.

### CROSS-REFERENCE TO RELATED APPLICATIONS

The present application claims priority on U.S. provisional patent application No. 61/773,640, filed on Mar. 6, 2013, and on U.S. provisional patent application No. 61/810,401, filed on Apr. 10, 2013.

### BACKGROUND OF THE INVENTION

In recent years, there has been significant progress in developing light sources which are longer lasting, and which use less energy, than a conventional incandescent light bulb. LED light sources are increasingly replacing not only standard incandescent bulbs, but also halogen lamps and fluorescent tubes. Such LED light sources can provide energy savings of up to 80% compared to incandescent bulbs and are much longer lasting.

Additional progress in developing improved light sources involves the use of lighting systems with intelligent controls. For example, infra-red sensors and motion sensors can be used to detect the presence of a user and a processor, in response, turns a lamp on. The controls can then leave the lamp on for a predetermined period after the user leaves. Alternatively, the controls can control the light source based on the actual purpose of the light. Most controls are wireless and connected through the power line itself. Control of the lamp is effected using an external box connected between a power socket and the lamp. In addition to such light sources, which act as a “client,” receiving inputs for the operation of the lamp, addition functions through embedded IEEE802.11n access point technology can be implemented such that with multiple-in/multiple out antenna technology incorporated, the box and light source together are able to communicate with other light sources, sense the environment, communicate with other client devices, etc. as if it were a standard IEEE802.11n “mesh” access point, such that the limitations of the light sources with “client” function only, will be overcome. This will allow the system to encompass a much larger area of operation, more devices can be controlled, and actively provide input to the light source based on inputs from the sensors in the particular locality.

### SUMMARY OF THE INVENTION

A network comprises a plurality of modules, wherein each module comprises a communications circuit with an antenna for sending information signals to, and receiving control signals from, a remote base over a wireless connection, preferably a wifi connection. Each module includes either a lighting element or a security camera. Each module may further include sensors to provide information to the base concerning current operating conditions of the module. Preferably, each module is programmed to receive signals from other modules and to relay such signals to the remote base, and similarly route control signals from the remote base intended for a different module to the intended module. In one embodiment, the network is a lighting network in which each module includes a light source controlled by the remote base.

Preferably, the communications circuit of each module is programmed to relay signals received from any other module in the network to the remote base, either directly, or indirectly by routing such signals to another module.

Preferably, the communications circuit of each module is programmed to determine, prior to sending signals received from one module to another module, whether such other module is operational and, if not, to select a different module for transmission.

Preferably, the network further comprises a control terminal remote from the central computer and the lighting modules and which is connectable to the central computer for controlling the central computer for generating the control signals. The control terminal is connectable to the central computer over a wifi connection or by cable.

The lighting network may be used to control any suitable lighting fixture including light bulbs, LED fluorescent tubes, street lamps, spot lights, theatrical lights, high bay lighting fixtures, or parking lot overhead lights.

In one embodiment, each of the modules comprises a surveillance camera electrically connected to the control circuit of the module to transmit surveillance images to the central computer over the wireless connection (preferably wifi). The lighting module may further include an infra-red light source which is activated in low light conditions.

In an embodiment of the invention, the lighting module further comprises at least one sensor for sensing a condition relevant to the operation of the light source. Signals which represent such condition are sent to the central computer, which can modify control signals according to current conditions. Examples of sensors which may be used include a smoke detector, a carbon monoxide detector, a motion sensor, a thermometer, a humidity sensor, and an ambient light level detector.

### BRIEF DESCRIPTION OF THE DRAWINGS

FIG. 1 is a schematic drawing of a lighting module according to an embodiment of the invention employing LEDs;

FIG. 2 is a schematic drawing of an example of an electrical control system which may be employed in the various embodiments of the invention;

FIG. 3a is a schematic drawing of a wireless communications circuit which may be employed in the various embodiments of the invention;

FIG. 3b is a schematic drawing of various embodiments of transmitter/receiver circuits and antennas which may be employed in the various embodiments of the invention;

FIG. 4 is schematic drawing of an example of a wireless lighting network according to the invention;

FIG. 5 is a schematic drawing of a second example of a wireless lighting network according to the invention;

FIG. 6 is a schematic drawing of a third example of a wireless lighting network according to the invention;

FIG. 7 is a schematic drawing of a fourth example of a wireless lighting network according to the invention;

FIG. 8 is a schematic drawing of a fifth example of a wireless lighting network according to the invention;

FIG. 9 is a schematic drawing of a street lamp system utilizing the invention;

FIG. 10 is a schematic drawing of an alternative embodiment of a lighting module;

FIGS. 11A-11G are schematic drawings of alternative applications of a lighting module;

FIGS. 12-13 are schematic drawings of additional applications of a lighting module employing video cameras;

FIG. 14 is a schematic drawing of a control system for the video cameras of FIGS. 12-13;

FIG. 15 is a schematic drawing of an alternative lighting module according to the invention; and

FIGS. 16-18 are schematic drawings of other embodiments of a lighting module according to the invention.

### DETAILED DESCRIPTION OF THE INVENTION

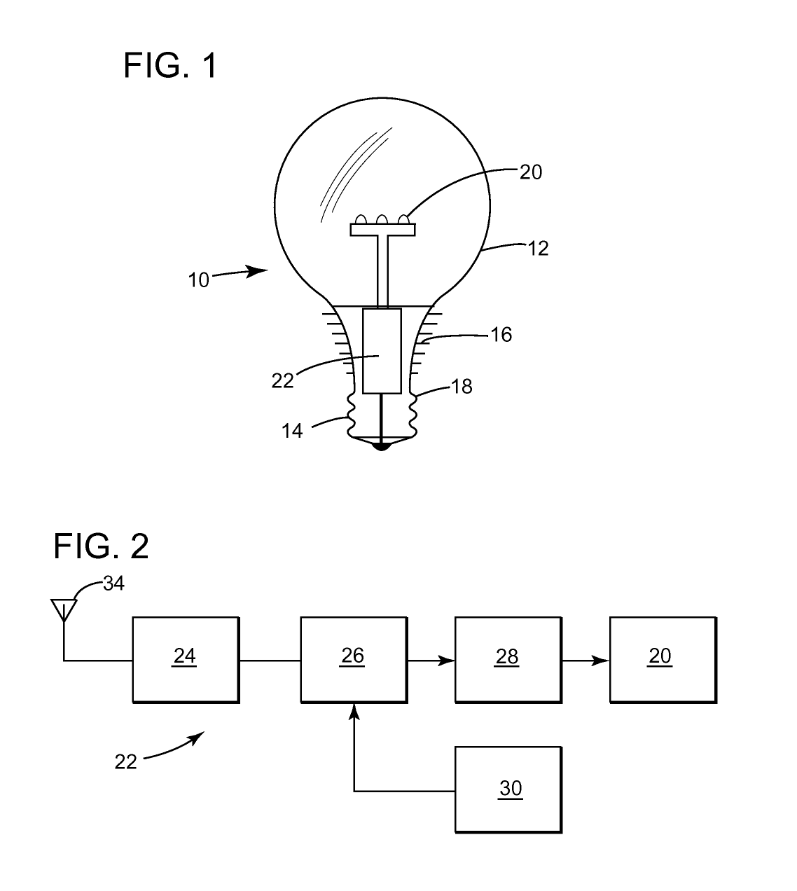

FIG. 1 shows an embodiment of the invention wherein the lighting module 10 is a standard Edison-type light bulb with a transparent or frosted bulb 12 and a standard, screw-in base 14. A heat sink 16 is provided about the neck 18 of the bulb 12. The heat sink 16 shown comprises a plurality of annular fins, the front face of which are omitted for clarity, however any suitable type of heat sink may be employed. A light source, in the form of one or more LEDs 20, is disposed within the bulb 12 and connected electrically to system circuits 22, described further below. In the example, the system circuits 22 are secured within the interior of the bulb 12 and are positioned inside of the heat sink 16. The interior of the bulb 12 is preferably sealed from outside air to prevent humidity from entering.

As shown in FIG. 2, the system circuits 22 include a wireless communication circuit 24 connected to an antenna 34, a control circuit 26, a drive circuit 28 for the LEDs, and a sensor circuit 30 containing a plurality of sensors. The control circuit 26 is electrically connected to the wireless communication circuit 24 for sending and receiving control signals. The wireless communication circuit 24, which is described in greater detail below, receives control signals from a remote location and can send signals, e.g., from sensor data, to the remote location, using the antenna 34.

The drive circuit 28 is electrically connected to the control circuit 26 and to the LEDs in a known manner such that the control circuit 26 controls the LEDs, e.g., to turn the LEDs on and off and act as a dimmer. The control circuit 26 receives control signals from the wireless communication circuit 24 to control the operation of the LEDs, for example, signals to turn the LEDs on or off, or to adjust the lighting intensity.

The sensor circuit 30 is electrically connected to the control circuit 26 and includes a plurality of sensors (not shown). Examples of sensors which may be employed include temperature sensors, light sensors, and humidity sensors. Sensor readings indicative of the environmental conditions around the lamp are provided to the control circuit 26 and are used to control the LEDs. Sensor readings may also be provided to the wireless communications circuit 24 and transmitted to a remote location for monitoring and controlling the control circuit 26.

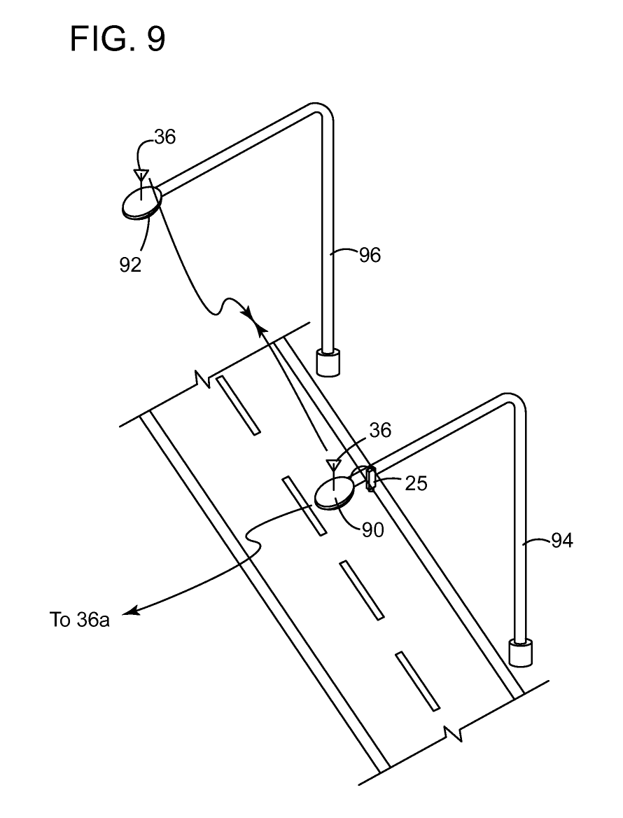

The sensors can also include microphones and a video camera whose signals can be transmitted by the wireless communication circuit 24 to a remote location and used for security or other functions. For example, as shown in FIG. 9, which schematically depicts a pair of street lamps 90, 92, a video camera 25 can be disposed in, or mounted adjacent to, the street lamps 90, 92. The signal from the video camera 25 is sent, either by electrical connection or wirelessly, to the control circuit 26, which re-transmits the signal, using the communication circuit 24 and antenna 34, to a remote location for controlling traffic signals or monitoring the road for accidents.

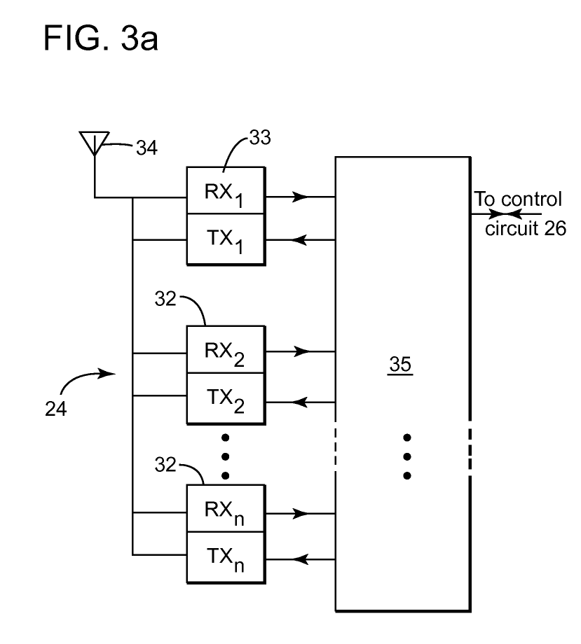

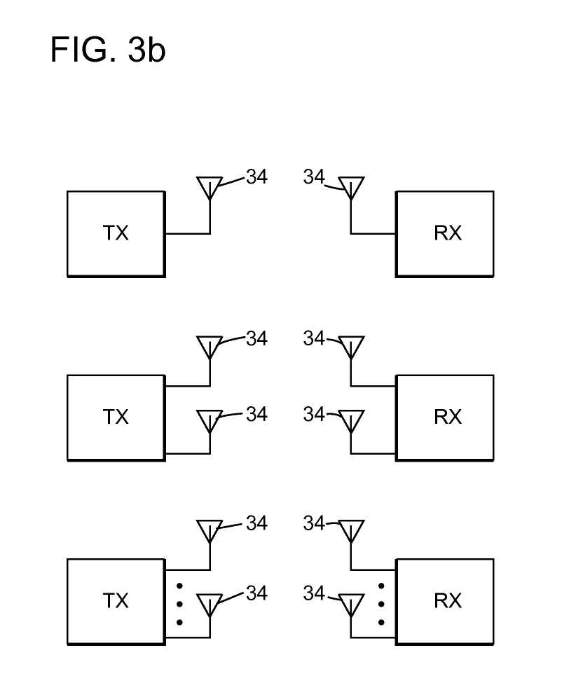

FIG. 3 shows an example of a wireless communications circuit 24 that may be used with the invention. The circuit includes one or more transmitter/receiver circuits (“TX/RX”) 32 connected to a processor 35. TX/RX circuits 32 receive control signals from, and send signals to, a remote location 40 wirelessly through an antenna 36. Signals received from the RX circuits are processed and sent by the processor 34 to the control circuit 26. Signals from the control circuit 26, including sensor readings, will be processed and sent to the remote location by the TX circuit. As shown in FIG. 3a, multiple TX/RX circuits may be used for accommodating different frequencies in order to communicate with multiple devices.

Although for simplicity FIG. 3a shows a single antenna 36 for the TX/RX circuit 32, preferably the invention employs MIMO antennas (multiple-input, multiple-output antennas) 34 of the type developed by Bell Labs in the 1990s, various examples of which are depicted schematically in FIG. 3b. The use of multiple MIMO antennas allows for transmission and receiving of a diversity and multiple streams of signals. Preferably, a minimum of 2×2 array will be used, and implemented with standard IEEE802.1 technology. MIMO antenna technology offers significant increases in data throughput and link range without requiring additional bandwidth or increased transmission power. For simplicity, the discussions and drawings in this application generally refer to the use of a single antenna, and in some applications a single antenna will suffice. However, MIMO antenna technology may be used in all embodiments.

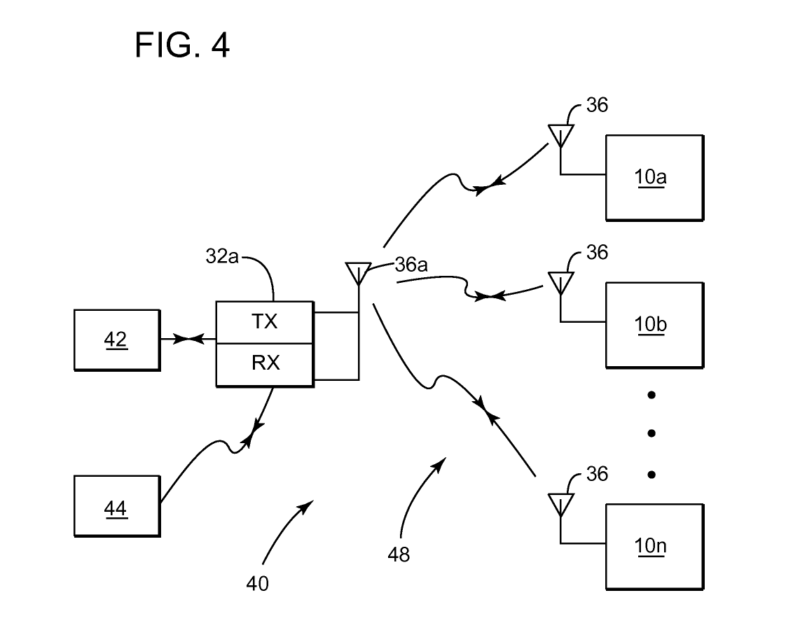

FIG. 4 shows schematically a first embodiment of a lighting network 40. The network 40 includes a central computer 42 electrically connected to a TX/RX circuit 32a for sending and receiving information wirelessly using antenna 36a. The central computer 42 can be a standard desktop computer or a network computer serving a group of users. A control terminal 44 is a computer connected to the central computer 42 either through a wired connection or through a wireless network such as wifi. A plurality of lighting modules 10a, 10b, 10n, each with an antenna 36, is connected with the central computer 42 through the wifi network 48 such that two way communication is possible.

Control information from the control terminal 44 can be sent to the central computer 42, which in turn sends control information to the lighting module 10a, 10b, or 10n. In such a manner, control signals such as on or off, or dimming, can be sent to the appropriate lighting module. The signals will be received by the lighting module's antenna and forwarded to the module's communication circuit (TX/RX circuit 32). Such signal, as described above, will be processed by the lighting module's control circuit 26 and drive the LEDs accordingly using the LED drive circuit 28.

Each lighting module 10a, 10b, 10n will have its own identity code, similar to standard wifi devices, which can be standard IP addresses or addresses with other coding schemes. In such a manner, the central computer 42 can send control signals to each lighting module separately.

In an embodiment, an RFID chip is physically embedded inside the lighting module during the manufacturing process. When the identity code is encoded into the lighting module later on, the identity code will be recorded into a database together with the RFID code. This tabulated data will be provided to the end user of the lighting module. During installation, the RFID code will be scanned and the corresponding identity code will be retrieved from the database for communication purposes.

In the example of FIG. 4, all lighting modules 10a-10n communicate directly with the central computer 42 through the wifi network 48. In certain cases, when the light modules 10 are far away and out-of-range of the wireless TX/RX circuit 36a, the wireless network needs to be configured differently. For example, referring to FIG. 9, if the system is used in street lamps 90, 92, the distance between individual lamp posts 94, 96 is not great, but the distance between the first lamp post 94 and the last lamp post (not shown) on a long street can exceed the range of a typical TX/RX wifi module.

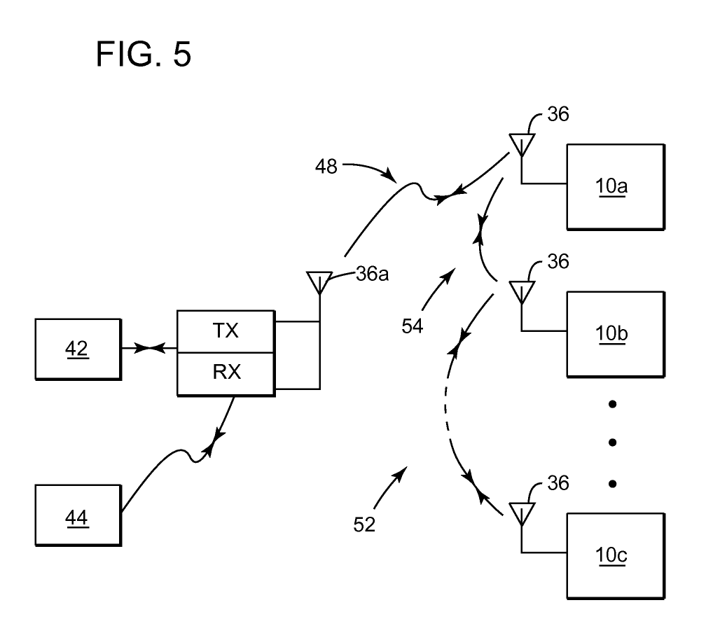

FIG. 5 shows schematically a second embodiment of a lighting network 50. The network 50 is similar to the network 40 described in connection with FIG. 4, except that not all lighting modules 10a, 10b, and 10n communicate directly with the central computer 42. In the example of FIG. 5, only the lighting module 10a (which, in FIG. 9 corresponds to street lamp 90) nearest to the antenna 36a communicates directly with the central computer 42. The second lighting module 10b (which in FIG. 9 can correspond to street lamp 92 or some other, more remote street lamp) communicates with the first lighting module 10a, whose processor 34 is programmed, upon receiving a signal from module 10b, to retransmit such signal to the central computer 42. Similarly, upon receiving a control signal from the central computer 42 intended for module 10b, the processor 34 of lighting module 10a is programmed to retransmit such signal to lighting module 10b. Thus, lighting module 10a acts as a relay station for communications between the central computer 42 and lighting module 10b.

In a similar manner, signals to and from lighting module 10n may be received and retransmitted to the central computer 42 by the first lighting module 10a. Alternatively, if the wifi RX/TX circuit of lighting module 10n is out of range of the first lighting module 10a, the signals from lighting module 10n are transmitted over wifi link 52 to another, more nearby lighting module, for example, the second lighting module 10b, and relayed over wifi link 54 by the second lighting module 10b to the first module 10a, which in turn relays the signals to the central computer 42 over wifi line 48.

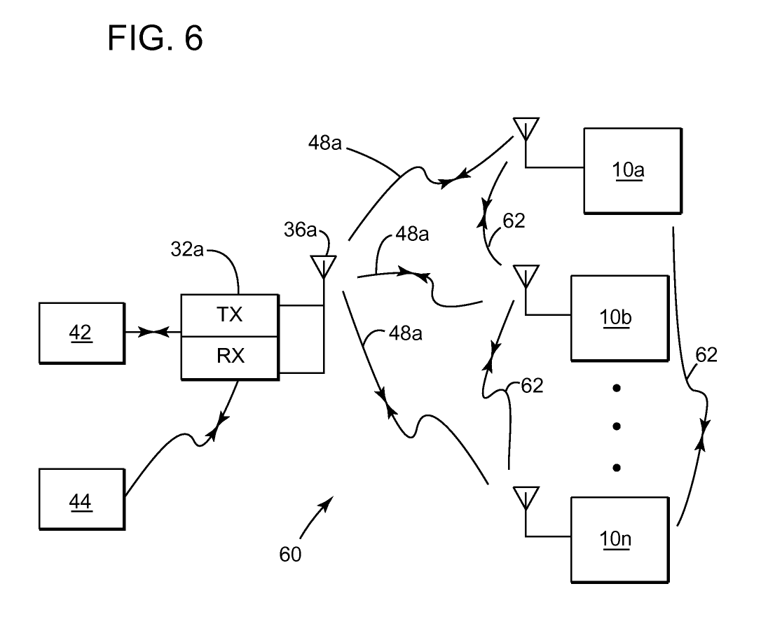

FIG. 6 shows a third embodiment of a lighting network 60. The FIG. 6 network 60 is similar to the networks 40 and 50, except that each lighting module 10a, 10b, and 10n can communicate directly over wifi link 48a with the central computer 42 and, in addition, can communicate over wifi link 62 with at least one of the other lighting modules. The ability of each module 10a, 10b, 10n to communicate over multiple paths provides robust communication connections between modules and permits communications to continue in the event that one or more wireless links are broken, which can occur due to distances, weather conditions, etc. In the event that a lighting module 10a, 10b, or 10n, or the central computer 42, is not able to establish a communication link over its default wireless link, the processor of such module or the central computer 42 is programmed to attempt to send the communication over a different path.

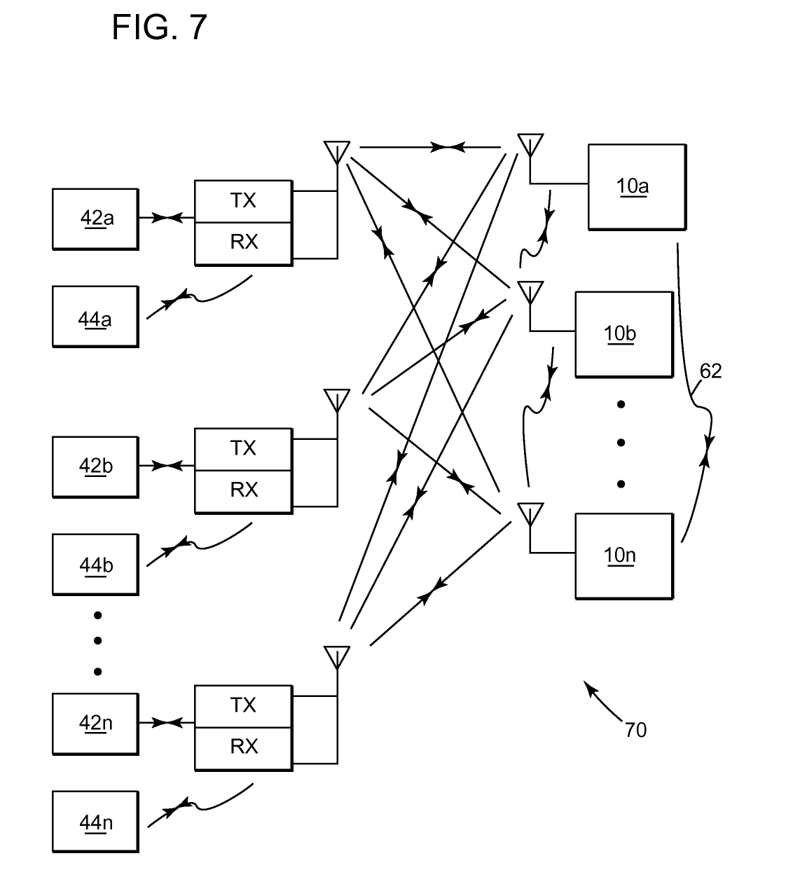

FIG. 7 illustrates schematically a fourth embodiment of a lighting network 70 containing multiple central computers 42a, 42b, and 42n, and multiple control terminals 44a, 44b, 44n. Each control terminal and central computer pair may be used independently to control multiple lighting modules 10a-10n. As shown, each central computer 42a, 42b, and 42n can communicate with any lighting module 10a-10n directly over a wifi link. The use of multiple central computers 42a, 42b, and 42n allows for additional system flexibility. However, the central computers need to communicate with one another and include software so as to avoid sending conflicting signals to the various lighting modules 10a-10n.

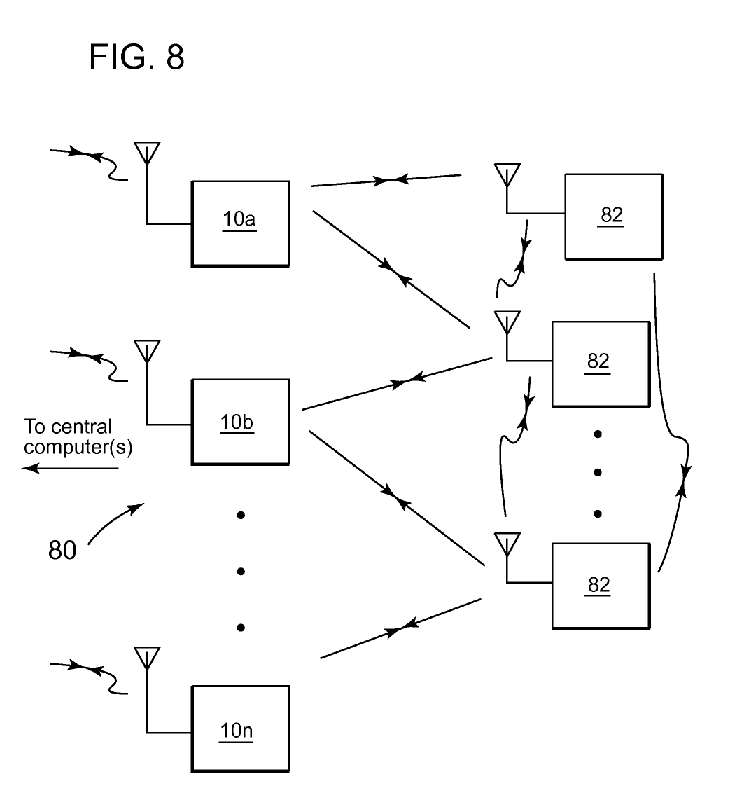

FIG. 8 illustrates schematically a fifth embodiment of a lighting network 80. The network 80 includes a plurality of auxiliary terminals 82 that utilize the wifi links established between the lighting modules 10a, 10b, 10n and the central computer 42, but which are not necessarily involved in the control of the lighting modules 10a, 10b, 10n. The terminals 82 take advantage of this potentially large wifi network for communication over distances which are out-of-range of the individual auxiliary terminals 82. Also, due to the redundancies of the interconnected wifi links of the lighting network, communications are not as subject to local disruptions of service.

Examples of auxiliary terminals 82 which can use the lighting network wifi include walkie-talkies which have been modified to include two way voice communication with wifi capabilities. Two walkie-talkies may be located at distances from one another which are too great for communications. However, if both walkie-talkies are able to communicate with the lighting network wifi system, they can communicate with one another using the lighting network's wifi network. This can be greatly advantageous in the case of disasters, for example where firemen and other first response rescuers need to communicate with one another but the distances are out-of-range of the walkie-talkies. Using the wifi network established by the lighting network, such personnel can communicate with one another even if some of the lighting modules are damaged or destroyed.

Another example of auxiliary terminals 82 are communication devices used by stage performers and associated background operations. Such devices communicate with the network and can include a microphone and an optional earphone for two-way communications. The microphone can be a studio quality microphone for use by a singer or other performer such that the audio is transmitted wirelessly to the associated broadcast and/or amplification and loud speaker systems. One important parameter for the design for such system is minimization of the signal delay between the microphone and the loud speaker. Such implementation will allow theaters to communicate using the frequency band of the wifi system, and allow a larger number of terminal devices to be used simultaneously. This is especially important when multiple theaters are located close to one another and whose signals could potentially interfere with one another using traditional wireless microphone systems.

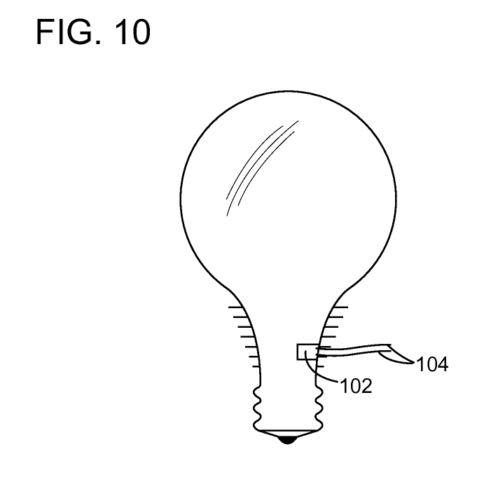

FIG. 10 shows an alternative embodiment of a lighting module 100 which is similar to the lighting module 10 described in FIG. 1, except that, instead of using wireless communications with transmitters and receivers connected to antennas, the control circuit 26 (not shown) is connected to an exterior connector receptacle 102 adapted to connect, e.g., to USB or RJ45 cables. The control circuit 26 may thus be connected to the central computer 42 by data cables 104. Alternately, the data cables 104 may be connected to another device for wireless transmission of data to and from the central computer 42.

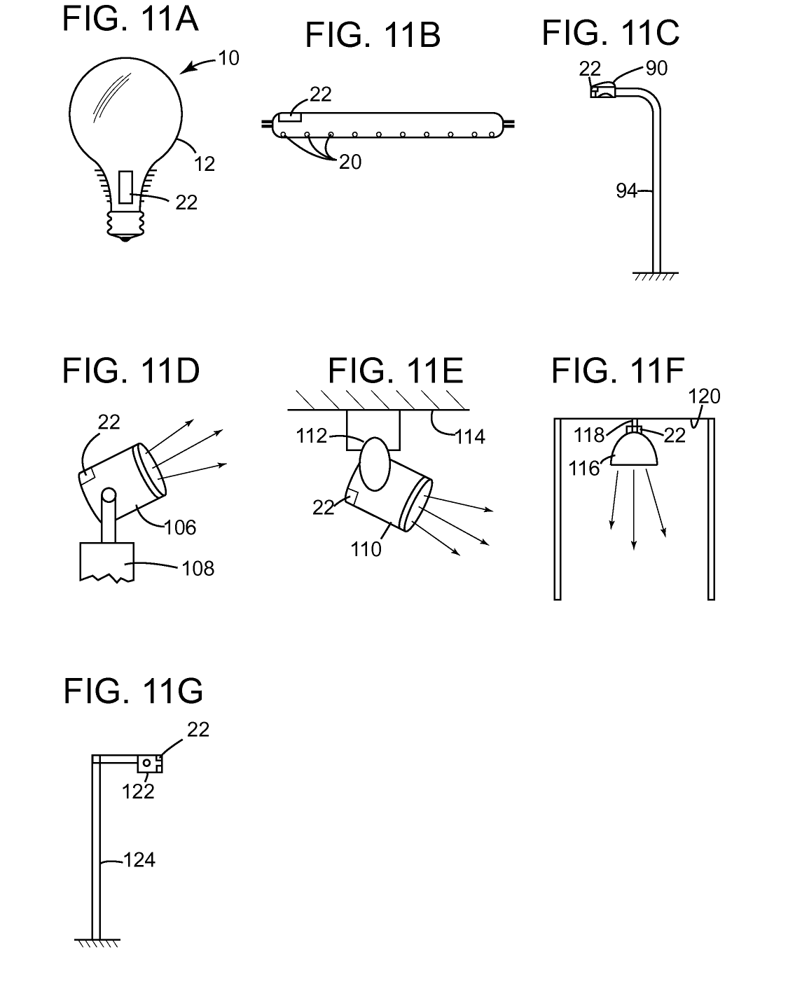

FIG. 11A shows schematically an embodiment of the invention as a screw-in light bulb 10. FIG. 11B shows schematically an embodiment of the invention as a fluorescent tube with a plurality of LEDs. FIG. 11C shows schematically an embodiment of the invention as a street lamp 90 mounted on a lamp post 94. FIG. 11D shows schematically an embodiment of the invention as a spotlight 106 mounted on a base 108. FIG. 11E shows schematically an embodiment of the invention as a theatrical light 110 hung by hardware 112 from a ceiling 114. FIG. 11F shows schematically an embodiment of the invention as a high bay, overhead lighting system 116 hung by hardware 118 from a ceiling 120. FIG. 11G shows schematically an embodiment of the invention as an outdoor parking lot lamp 122 hung from a post 124. Each of these embodiments includes a housing containing the lighting module and the system circuits 22.

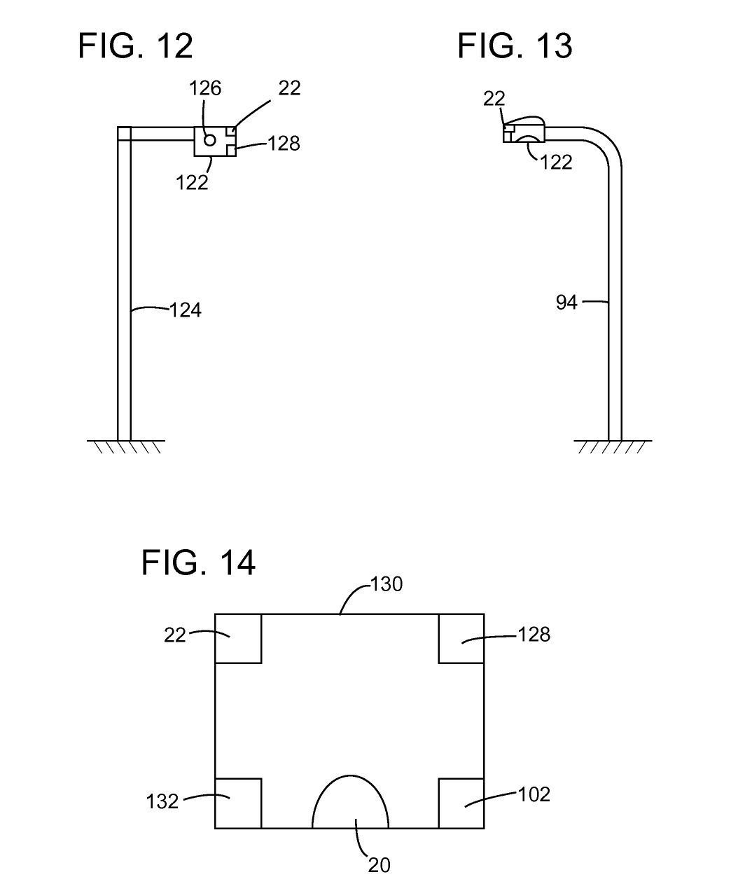

FIG. 12 shows schematically a parking lot lamp 122 hung from a post 124 which includes a lamp 126 and camera 128 housed within a housing 130. FIG. 13 shows schematically the same lamp 122 used as a street lamp supported by a lamp post 94. In both FIG. 12 and FIG. 13, the camera 128 is integrated with the lighting module such that the lighting fixture can have the added function of video monitoring with the video content transmitted to the central computer 42 as shown, e.g., in FIGS. 4-8 as part of the lighting network. Such lighting module having an integrated camera, when used in street lamps, act as a combined lighting source and surveillance camera.

To allow continuous video capability during times when the lighting module is off, FIG. 14 illustrates an example of a lighting module 130 which, in addition to a lighting source, e.g., LEDs 20, camera 128, and system circuits 22, includes an infrared light source 132. The system circuits 22 are programmed to turn on the infrared light source 132 when the LEDs are off (at least at night, which can be determined by a sensor) so that the camera 128 can operate as a security camera at night. The infra red source 132 and camera 128 may draw power from the same power source used to light the lighting module 130, even when the lighting module is off. The FIG. 14 embodiment includes the option to connect an external camera to the lighting module 130 using a USB or RJ45 receptacle or equivalent.

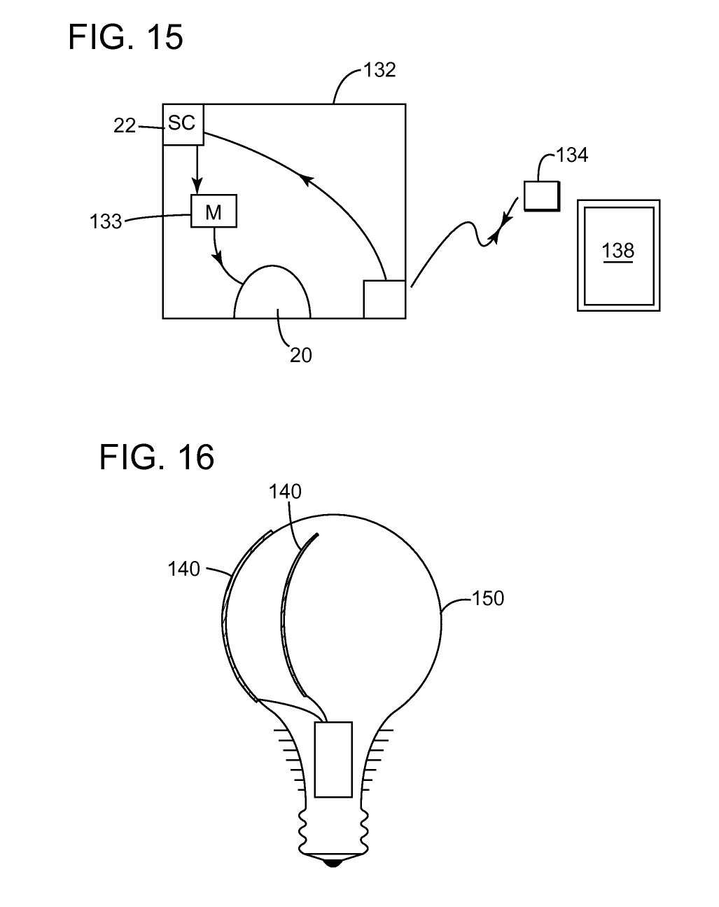

In the embodiment shown in FIG. 15, the lighting module 132 can be used to communicate with a user device 134 through the LED light source itself through using modulator 135, by modulating the light output using various schemes of modulations such as amplitude modulation, frequency modulation, pulse modulations, etc. This can also be done using the base band signals or through a carrier frequency band. In another embodiment, an extra IR LED light source can be used for data transmission such that the LED light source can be turned off during operation when light is not needed while maintaining the communication link.

In addition, two-way communications can be achieved by adding an optical detector 136 to the lighting module 132 such that information from the user device 134 can be modulated, sent to the light module, and be detected by the optical detector 136. Such information can then be transmitted to other parts of the network. Since optical communications between the lighting module and the user are limited to line-of-sight transmissions, they remain local, in the proximity of the lighting device for better security. An example of such a system for one-way communication can be audio and video information transmitted to the patrons of a museum. A light module can be placed above, or the side of, each piece of artwork 138. The user device 134, which can be a headphone, speaker or handheld video display, can receive information locally next to the artwork. A two-way communication system can be a data terminal used by supermarket inventory clerk entering information at various aisles of the market.

For effective transmission of data between the lighting modules, a well-designed and positioned antenna system is important. Beside the length of the antenna, often multiple antennas are used with phase control pointing the signal in a certain direction with extended ranges. FIG. 16 shows schematically an embodiment in which one or more antennas 140, 140a are designed as an integral part of the light bulb 150. The antennas 140, 140a are in the form of thin, conductive strips on the surface of the light bulb 150. The antennas 140, 140a are spaced from, and oriented relative to, one another to optimize the signal transmissions. In the example, two vertical strips, running along radii at about a 30 degree angle from one another, are used. Such thin, conductive strips function as effective antennas without substantially blocking the light output of the light bulb.

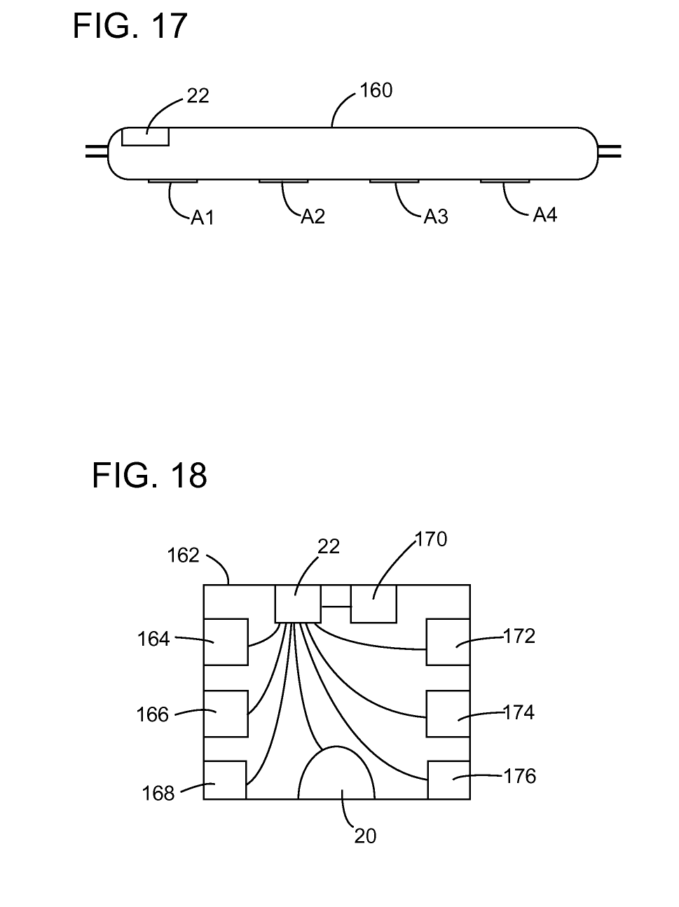

FIG. 17 shows schematically an embodiment of an antenna implementation, A1-A4. in an LED tubular light source 160, which may be used as a replacement for a standard fluorescent tube. One or more antennas A1-A4, each in the form of a thin, conductive strip, will allow effective use of the transmitter power and, through the use of phase control, extended range can be achieved in a selected direction. In the example, the four strips are co-linear with one another and have a common spacing. Other configurations, however, may be employed to optimize the signal.

FIG. 18 shows schematically a lighting module 162 with system circuits 22 connected to various function modules including a smoke detector 164, a carbon monoxide detector 166, a speaker 168, a motion sensor 170, a thermometer 172, a humidity sensor 174, and an ambient light detector 176 for sensing brightness and color. In this embodiment, the light source 20 is indicated as optional as such lighting module can be installed to perform selected function without the need of light in certain locations and applications. Such lighting module 162 can be made at low cost when the lighting function s eliminated.

In the previous examples, the lighting source is one or more LEDs 20. However, any controllable light source may be used as part of the network, such as standard light bulbs with Edison sockets which may be LED or non-LED, fluorescent tubes or LED equivalents, LED and non-LED street lamps, parabolic aluminized reflectors (Par lamps), LED and non-LED spot lights, LED and non-LED theatrical lighting systems, LED and non-LED high bay lighting systems, LED and non-LED parking lot lighting systems, and other known lighting systems. Examples of such systems are given in FIGS. 11A-11G.

The system according to the invention provides a light source that can be controlled wirelessly and is able to perform other functions through embedding IEEE802.11n access point technology in the external control box for the lighting module. With multiple-in/multiple-out antenna technology used, the box and light source together are able to communicate with other light sources, sense the environment, communicate with other client devices, as if they were a standard IEEE8021n “mesh” access point, such that the limitations of conventional light sources, with “client’ function only, will be overcome. This will allow the system to encompass a much larger area of operation. More devices can thus be controlled, and inputs from the sensors may be used to actively control each light source.

The various wireless links described in the specification can be achieved using standard wireless wifi technology or other radio technologies. Although only the functions of the wireless links are described herein, for standardization, cost, size and availability considerations, most of the functions will be performed using standard wifi technology. For example, radio frequencies of 2.4 GHz and 5 GHz may be used. The connections to computers, tablets, smart phones, or other suitable devices used as the control terminal can be via standard IEEE802.11n protocol. Other technologies include repeater, access points, relays, boosters, etc. use standard integrated circuit chips which are readily available at low cost.

The foregoing description represents the preferred embodiments of the invention. Various modifications will be apparent to persons skilled in the art. All such modifications and variations are intended to be within the scope of the invention, as set forth in the following claims.

1. A lighting module comprising:
a light source;
a control circuit for controlling the operation of the light circuit;
a communications circuit including a processor and an antenna, wherein said processor is connected to communicate with the control circuit; and
a remote base having a central computer and an antenna;
wherein said communications circuit is programmed to receive and process control signals from said remote base over a wireless connection for controlling the control circuit and for sending signals to the remote base over said wifi wireless connection.

2. The lighting module according to claim 1, wherein said light source comprises at least one LED controlled by a drive circuit, and wherein said control circuit is connected to control said drive circuit.

3. The lighting module according to claim 1, further comprising at least one sensor for sensing a condition relevant to the operation of the light source, wherein said sensor is electrically connected to said control circuit for supplying condition signals representative of such condition; and wherein said control circuit is programmed to transmit, at least on a predetermined basis, such condition signals to the remote base using the communications circuit.

4. The lighting module according to claim 3, wherein said central computer is programmed, responsive to receiving condition signals, to modify said control signals for controlling the control circuit.

5. The lighting module according to claim 1, wherein said light source comprises a light bulb having a curved, rounded, or spherical bulb portion and a base, and wherein said antenna comprises at least one antenna strip mounting on said round bulb portion.

6. The lighting module according to claim 5, wherein said antenna comprises two antenna strips mounted on said bulb portion at a predetermined spacing and orientation relative to one another.

7. A lighting network comprising a plurality of lighting modules, wherein each module comprises:
a light source;
a control circuit for controlling the operation of the light circuit;
a communications circuit including a processor and an antenna, wherein said processor is connected to communicate with the control circuit; and
a remote base having a central computer and an antenna;
wherein said communications circuit is programmed to receive and process control signals from said remote base over a wireless connection for controlling the control circuit and for sending signals to the remote base over said wifi wireless connection.

8. A lighting network comprising a plurality of lighting modules, wherein each module comprises:
a light source;
a control circuit for controlling the operation of the light circuit;
a communications circuit including a processor and an antenna, wherein said processor is connected to communicate with the control circuit; and
a remote base having a central computer and an antenna;
wherein said communications circuit is programmed to receive and process control signals from said remote base over a wireless connection for controlling the control circuit and for sending signals to the remote base over said wifi wireless connection;
wherein the communications circuit of at least one lighting module is programmed to receive signals from a second lighting module and to relay such signals to the remote base; and wherein the communications circuit of the at least one lighting module is further programmed, upon receiving control signals from the remote base intended for the second lighting module, to relay such control signals to the second lighting module.

9. The lighting network of claim 8, wherein the communications circuit of each module is programmed to relay signals received from any other module in the network to the remote base, either directly, or indirectly by routing such signals to another module.

10. The lighting network of claim 9, wherein the communications circuit of each module is programmed to determine, prior to sending signals received from one module to another module, whether such other module is in operation and, if not, to select a different module for transmission.

11. The lighting network of claim 7, further comprising a control terminal remote from said central computer and said lighting modules and which is connectable to said central computer for controlling said central computer for generating said control signals.

12. The lighting network of claim 11, wherein said control terminal is connectable to said central computer over a wifi connection.

13. The lighting network of claim 12, wherein the lighting modules are light bulbs.

14. The lighting network of claim 12, wherein the lighting modules are LED fluorescent tubes.

15. The lighting network of claim 12, wherein the lighting modules are street lamps.

16. The lighting network of claim 12, wherein the lighting modules are spot lights.

17. The lighting network of claim 12, wherein the lighting modules are theatrical lights.

18. The lighting network of claim 12, wherein the lighting modules are high bay lighting fixtures.

19. The lighting network of claim 12, wherein the lighting modules are parking lot overhead lights.

20. The lighting network of claim 15, wherein each of the lighting modules further comprises a surveillance camera electrically connected to said control circuit to provide surveillance images to said central computer.

21. The lighting network of claim 20, wherein each of the lighting modules further comprises an infra-red light source which is activated by said control circuit in low light conditions.

22. The lighting network of claim 19, wherein each of the lighting modules further comprises a surveillance camera electrically connected to said control circuit to provide surveillance images to said central computer.

23. The lighting network of claim 22, wherein each of the lighting modules further comprises an infra-red light source which is activated by said control circuit in low light conditions.

24. The lighting module of claim 8, further comprising at least one sensor for sensing a condition relevant to the operation of the light source, wherein said sensor is electrically connected to said control circuit for supplying condition signals representative of such condition; and wherein said control circuit is programmed to transmit, at least on a predetermined basis, such condition signals using the communications circuit.

25. The lighting module of claim 24, wherein said at least one sensor comprises one or more of a smoke detector, a carbon monoxide detector, a motion sensor, a thermometer, a humidity sensor, and an ambient light level detector.

26. A security network comprising a plurality of modules, wherein each module comprises:
a communications circuit including a processor and an antenna;
a control circuit for controlling the operation of the processor;
a remote base having a central computer and an antenna;
a security camera for providing images to said control circuit wherein said communications circuit is programmed to send images received form said control circuit to the remote base over a wireless connection using said communications circuit;
wherein the communications circuit of at least one module is programmed to receive signals from a second module and to relay such signals to the remote base; and
wherein the communications circuit of the at least one module is further programmed, upon receiving control signals from the remote base intended for the second module, to relay such control signals to the second lighting module.

27. The security network of claim 26, wherein the communications circuit of each module is programmed to relay signals received from any other module in the network to the remote base, either directly, or indirectly by routing such signals to another module.

28. The security network of claim 27, wherein the communications circuit of each module is programmed to determine, prior to sending signals received from one module to another module, whether such other module is in operation and, if not, to select a different module for transmission.

29. The lighting module of claim 1, wherein said wireless connection is a wifi connection.

30. The lighting network of claim 7, wherein said wireless connection is a wifi connection.

31. The lighting network of claim 8, wherein said wireless connection is a wifi connection.

32. The security network of claim 26, wherein said wireless connection is a wifi connection.
